(19) United States
(12) Patent Application Publication
(10) Pub. No.: US 2019/0366880 A1
(43) Pub. Date: Dec. 5, 2019

(54) VEHICLE SEAT, IN PARTICULAR MOTOR VEHICLE SEAT

(71) Applicant: ADIENT ENGINEERING AND IP GMBH, Burscheid (DE)

(72) Inventors: Thomas DILL, Heiligenmoschel (DE); Heinrich HAMANN, Teschenmoschel (DE); Olaf KREUELS, Zweibruecken (DE); Christian WOLF, Dielkirchen (DE)

(21) Appl. No.: 16/462,353

(22) PCT Filed: Nov. 14, 2017
(86) PCT No.: PCT/EP2017/079154

§ 371 Date: May 20, 2019

(30) Foreign Application Priority Data
Nov. 21, 2016 (DE) 10 2016 222 917.6

(51) Int. Cl. B60N 2/12; B60N 2/08

(52) U.S. Cl. CPC B60N 2/12; B60N 2/206; B60N 2/085

(57) ABSTRACT

A vehicle seat includes a seat part, a pivotable backrest, a lockable fitting connecting the backrest to the seat part for pivoting, a rail pair for seat longitudinal adjustment and a seat rail locking device. An additional rest lock includes a stop part rotationally fixed to the backrest, a retaining catch, a control lever and a control contour connected to a rail. The control contour acts on the control lever and the control lever acts on the retaining catch so these assume a different angular position in a seat access position than in a use position, such that the stop part pivots beyond the retaining catch in the use position, and the retaining catch prevents a pivoting beyond of the stop part in the access position. In the access position, the retaining catch is pivoted directly by a control catch to prevent a pivoting beyond of the stop part.

### CROSS REFERENCE TO RELATED APPLICATIONS

This application is a United States National Phase Application of International Application PCT/EP2017/079154 filed Nov. 14, 2017, and claims the benefit of priority under 35 U.S.C. § 119 of German Application 10 2016 222 917.6, filed Nov. 21, 2016, the entire contents of which are incorporated herein by reference.

### TECHNICAL FIELD

The relates to a vehicle seat, in particular motor-vehicle seat, having a seat part and a backrest, which can be pivoted about a pivot axis, having at least one lockable fitting for attaching the backrest to the seat part in a pivotable manner, having at least one pair of rails for adjusting the vehicle seat longitudinally, and having a seat-rail-locking device for locking the at least one pair of rails in at least one use position of the vehicle seat, said position being suitable for transporting passengers, wherein the vehicle seat can be transferred into an entry position, in which the vehicle seat has been displaced, in relation to the at least one use position, into an easy-entry region by means of the at least one pair of rails, the backrest has been pivoted forward about the pivot axis and the backrest can be locked in the forwardly pivoted position by means of an additional backrest-locking mechanism, which is formed separately from the at least one fitting, the additional backrest-locking mechanism having a stop part, which is connected to the backrest in a rotationally fixed manner, having an arresting catch, having a control lever and having a control contour, which is fixed to a vehicle-mounted rail, wherein the control contour acts on the control lever such that, in the entry position, the control lever assumes a different angular position than in the at least one use position, and the control lever is operatively connected to the arresting catch such that, in the entry position, the arresting catch assumes a different angular position than in the at least one use position, and therefore, in the at least one use position, the stop part can be pivoted past the arresting catch, and, in the entry position, the arresting catch prevents the stop part from pivoting past.

### TECHNICAL BACKGROUND

WO 2012/084116 A1 discloses a vehicle seat comprising a longitudinal adjuster having two pairs of rails each with two seat rails, namely an upper rail and a lower rail, which can be displaced relative to one another and engage around one another. The upper rail can be displaced relative to the lower rail within a comfort-setting region and, in addition, into an easy-entry region. A seat-rail-locking device is provided in order to lock the upper rail to the lower rail in a position within the comfort-setting region. The seat-rail-locking device does not function, that is to say the upper rail cannot be locked to the lower rail, in the easy-entry region. In order to delimit the comfort-setting region, the upper rail has provided on it an end-stop element with a movable stop surface, which interacts with an end stop arranged on the lower rail. In order to displace the lower rail out of the comfort-setting region into the easy-entry region, the end-stop element with the movable stop surface can be disengaged.

US 2012/0168595 A1 also discloses a vehicle seat which comprises a lower rail having an end stop and an upper rail having a stop element. The stop element and the end stop here delimit a comfort-setting region. The stop element can be disengaged by being pivoted about an axis, as a result of which the upper rail can be displaced, beyond the comfort-setting region, into an easy-entry region.

DE 10 2004 049 404 A1 discloses a vehicle seat which can be adjusted into a comfort-setting region and an easy-entry region. The upper rail has fitted on it a cam, which interacts with a stop strip, mounted on the lower rail, in order to delimit the comfort-setting region.

WO 2014/177351 A1 discloses a longitudinally adjustable vehicle seat comprising a lower rail and an upper rail, which is guided in the lower rail such that it can be displaced in the longitudinal direction within a comfort-setting region, and also comprising an end stop, which is fitted on the lower rail and delimits the comfort-setting region by interaction with a stop element fitted on the upper rail, wherein, by virtue of the stop element being disengaged, the upper rail can be displaced, beyond the comfort-setting region, into an easy-entry region, and wherein the stop element is part of a stop module, which can be pivoted about a pivot axis.

DE 10 2016 204 645 A1 discloses a vehicle seat having a seat part and a backrest, which can be pivoted about a pivot axis, having a lockable fitting for attaching the backrest to the seat part in a pivotable manner, having two pairs of rails for adjusting the vehicle seat longitudinally and having a seat-rail-locking device for locking the pairs of rails in a use position of the vehicle seat, said position being suitable for transporting passengers, wherein the vehicle seat can assume an entry position, in which the vehicle seat has been displaced, in relation to the use position, into a front longitudinal position by means of the pairs of rails, the backrest has been pivoted forward and can be locked in the forwardly pivoted position by means of an additional backrest-locking mechanism, which is formed separately from the fitting, wherein, in the front longitudinal position, the pairs of rails can be locked by means of an additional rail-locking mechanism, which is formed separately from the seat-rail-locking device.

### SUMMARY

The invention is based on the object of improving a vehicle seat of the type mentioned in the introduction. In particular, an additional backrest-locking mechanism is intended to prevent the situation where, in the unlocked easy-entry region of the longitudinal adjuster, a passenger can sit in the vehicle seat. The additional backrest-locking mechanism should act only in an easy-entry region. As soon as the seat, as it is pushed back out of the easy-entry region, reaches a comfort-setting region, the backrest should move back into the upright state again.

This object is achieved according to the invention by a vehicle seat, in particular motor-vehicle seat, having a seat part and a backrest, which can be pivoted about a pivot axis, having at least one lockable fitting for attaching the backrest to the seat part in a pivotable manner, having at least one pair of rails for adjusting the vehicle seat longitudinally, and having a seat-rail-locking device for locking the at least one pair of rails in at least one use position of the vehicle seat, said position being suitable for transporting passengers, wherein the vehicle seat can be transferred into an entry position, in which the vehicle seat has been displaced, in relation to the use position, into an easy-entry region by means of the at least one pair of rails, the backrest has been pivoted forward about the pivot axis and the backrest can be locked in the forwardly pivoted position by means of an additional backrest-locking mechanism, which is formed separately from the at least one fitting, the additional backrest-locking mechanism having a stop part, which is connected to the backrest in a rotationally fixed manner, having an arresting catch, having a control lever and having a control contour, which is fixed to a vehicle-mounted rail, wherein the control contour acts on the control lever such that, in the entry position, the control lever assumes a different angular position than in the use position, and the control lever is operatively connected to the arresting catch such that, in the entry position, the arresting catch assumes a different angular position than in the use position, and therefore, in the use position, the stop part can be pivoted past the arresting catch, and, in the entry position, the arresting catch prevents the stop part from pivoting past, wherein, in the entry position, the arresting catch has been pivoted directly by a control catch such that the arresting catch prevents the stop part from pivoting past, wherein, in the entry position, the arresting catch has been pivoted directly by a control catch such that the arresting catch prevents the stop part from pivoting past.

Since, in the entry position, the arresting catch has been pivoted directly by a control catch such that the arresting catch prevents the stop part from pivoting past, and thus the backrest from pivoting back, it is not possible for a passenger to sit in the vehicle seat in the unlocked easy-entry region of the longitudinal adjuster.

The arresting catch can be prestressed by means of a spring in the direction of an angular position of the arresting catch, in which the arresting catch allows the stop part to pivot past. This makes it possible to ensure that the arresting catch is reliably kept open as soon as the vehicle seat is located in the comfort-setting region.

The control lever preferably has a finger, wherein, within the comfort-setting region, the finger rests on the control contour. This means that it is only the finger of the control lever which is in contact with the control contour, and therefore the friction between the control lever and the control contour is reduced. A spring which acts on the control lever can prestress the finger in the direction of the control contour.

The control catch can be connected to the control lever via a coupling element. This makes it possible for the control catch and the control lever to be arranged more or less in any desired manner in relation to one another within a large installation region, and therefore they can also be arranged in restricted or disadvantageous installation spaces. The coupling element can be a wire. The coupling element can be a sheet-metal component. The coupling element preferably has an elongate extent, and it is therefore possible to bridge relatively large distances between the control catch and the control lever. A first end region of the coupling element can be connected in a pivotable manner to a point of articulation of the control catch. A second end region of the coupling element can be connected in a pivotable manner to a point of articulation of the control lever.

The arresting catch can have a stop surface for interacting with the stop part. The control catch can have a control cam for controlling a pivoting movement of the arresting catch. The arresting catch can have a cam, which projects in the direction of the control catch. The control cam butts against the cam of the arresting catch preferably such that pivoting of the control catch causes the arresting catch to pivot. A stop cam preferably delimits a pivoting-angle range of the control catch. In a locked state of the arresting catch, the stop cam preferably butts against the arresting catch.

It is possible to lock at least one pair of rails in the front longitudinal position by means of an additional rail-locking mechanism, which is formed separately from the seat-rail-locking device. This means that an occupant of a row of seats arranged behind the vehicle seat can hold onto the backrest and/or pull himself forward as he is exiting the vehicle. In the use position, the additional rail-locking mechanism can be open irrespective of a locking state of the seat-rail-locking device.

Both the locking of the backrest and the locking of the longitudinal position of the vehicle seat can take place by means of an additional locking mechanism. This gives rise to advantages described hereinbelow.

The vehicle seat needs to not have any special easy-entry components (fittings and rails with the additional possibility of locking an entry position). This makes it possible to design the vehicle seat in the form of a rear seat which is subjected to high loading, has integrated belts and in the case of which it is usually not possible to use special easy-entry fittings.

The backrest can be blocked with control by the longitudinal seat position. Since, in the entry position, the fittings are not locked (locking takes place via the additional backrest-locking mechanism), all that is required for active unlocking of the entry position is for the additional rail-locking mechanism to be released. During normal operation (in the use positions), the additional rail-locking mechanism is not in use. In order to transfer the vehicle seat from a use position into the entry position and back, only ever one locking mechanism has to be opened in each case. This has the advantage of no additional operating force having to be expended.

The invention will be explained in more detail hereinbelow with reference to an advantageous exemplary embodiment illustrated in the figures. However, the invention is not limited to this exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a vehicle seat according to the invention having an additional backrest-locking mechanism;

FIG. 2 is a detail-specific view of a region of the vehicle seat according to the invention which has the additional backrest-locking mechanism;

FIG. 3 is a detail-specific view corresponding to FIG. 2, wherein the additional backrest-locking mechanism is in an unlocked state and the vehicle seat is located in a use position;

FIG. 4 is a detail-specific view corresponding to FIG. 2, wherein the additional backrest-locking mechanism is in an unlocked state, the backrest of the vehicle seat has been pivoted forward slightly beyond an entry position, and a longitudinal-adjustment position is within a comfort-setting region;

FIG. 5 is a detail-specific view corresponding to FIG. 2, wherein the additional backrest-locking mechanism is in a locked state, the backrest of the vehicle seat has been pivoted forward slightly beyond an entry position, and the longitudinal-adjustment position is within an easy-entry region; and

FIG. 6 is a view corresponding to FIG. 5, wherein the backrest of the vehicle seat is located in the entry position.

### DESCRIPTION OF PREFERRED EMBODIMENTS

Referring to the drawings, a vehicle seat 1 will be described hereinbelow using a Cartesian coordinate system which is defined by three directions in space located perpendicularly to one another. In the case of a vehicle seat 1 installed in the vehicle, a longitudinal direction x runs largely horizontally and preferably parallel to a longitudinal direction of the vehicle, which corresponds to the customary direction of travel of the vehicle. A transverse direction, which runs perpendicularly to the longitudinal direction x, is likewise oriented horizontally in the vehicle and runs parallel to a transverse direction of the vehicle. A vertical direction z runs perpendicularly to the longitudinal direction x and perpendicularly to the transverse direction. In the case of a vehicle seat 1 installed in the vehicle, the vertical direction z runs parallel to the vertical axis of the vehicle.

The information used in relation to position and direction, for example forward(ly), rearward, upward and downward, relates to a viewing direction of an occupant of the vehicle seat 1 in the normal sitting position, the vehicle seat 1 being oriented, as is customary, in the direction of travel. However, the vehicle seat 1 according to the invention can also be installed with different orientation, for example transversely to the direction of travel.

The vehicle seat 1 has a seat part 3 and a backrest 5, which can be pivoted relative to the seat part 3 about a pivot axis S, which runs in the transverse direction and is defined by two fittings 7. The two fittings 7 here are operatively connected to one another via a transfer rod, which is likewise oriented in the transverse direction and is arranged concentrically in relation to the pivot axis S, and therefore unlocking of one of the two fittings 7 inevitably causes the other fitting 7 to unlock. In order to adjust the inclination of the backrest 5, an operating element 20 is operatively connected to the transfer rod on an outer side of the seat, and therefore actuation of the operating element 20 rotates the transfer rod. The two fittings 7 are thus opened and the backrest 5 can be pivoted relative to the seat part 3 about the pivot axis S. The fittings 7 can additionally be opened by means of an operating handle 70, arranged in an upper region of the backrest 5, in particular in order for an entry position to be assumed.

Each of the two fittings 7 comprises a first fitting part and a second fitting part, which, in the case of the fitting 7 being unlocked, can be rotated relative to the latter about the pivot axis S. When the fitting 7 is installed, the first fitting part is fixed to the structure of the backrest 5, that is to say mounted on the backrest, by means of an upper fitting part. The second fitting part is fixed to the structure of the seat part 3, that is to say is mounted on the seat part, by means of a lower fitting part. The two fittings 7 are each configured in the form of a latching fitting, as is known, for example, from DE 10 2009 041 492 A1.

In the present case, actuation of the operating element 20 can move the backrest 5 into a comfort-angle setting, which allows precision adjustment of a backrest-inclination angle about the pivot axis S within a small comfort-angle range (for example by up to 10° rearward, and up to 2° forward, in relation to the vertical direction z) around a central use position. All the backrest-inclination angles within the comfort-angle range are use positions of the backrest 5. However, it is also possible for the comfort setting of the backrest 5 to be dispensed with.

The vehicle seat 1 is attached to a structure of the vehicle such that it can be displaced in a longitudinal direction x by means of two pairs of rails, which are oriented in the longitudinal direction x and are known per se. The two pairs of rails comprise two first rails 11, which can be moved relative to the vehicle structure and are arranged parallel to one another, and two associated, second rails 13, which are mounted on the vehicle structure and engage around, and guide, the first rails 11. A respective seat-rail-locking device 17, which is known per se, can be used to lock the respectively first rails 11 to the respectively second rails 13 in a longitudinal-adjustment position, which is located within the comfort-setting region. In the case of the seat-rail-locking devices 17 being unlocked, the first rails 11 can be displaced relative to the second rails 13 and it is thus possible to alter the position of the vehicle seat 1 in the longitudinal direction x relative to the vehicle structure. In a modification of the exemplary embodiment, the vehicle seat 1 has just precisely one seat-rail-locking device 17, to be precise acting between one of the two pairs of rails 11, 13.

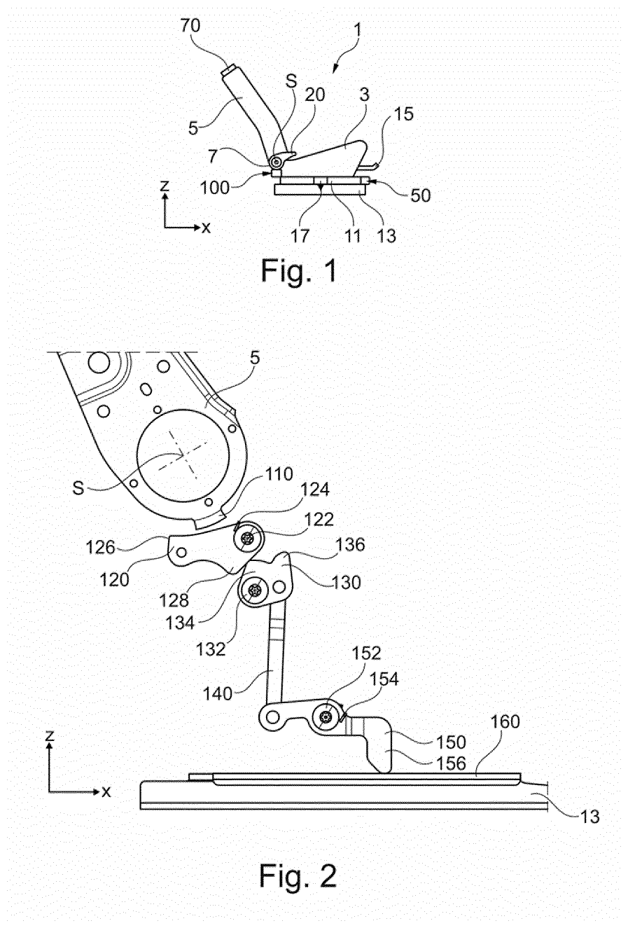

The backrest 5 of the vehicle seat 1 can be moved forward about the pivot axis S into an entry position from a use position, which is illustrated in FIG. 1, is inclined rearward in relation to the vertical direction z and is suitable for transporting passengers. In the entry position, the backrest 5 has been pivoted forward about the pivot axis S into an angular position in which it is pivoted forward in relation to the vertical direction z. In addition, when the entry position is reached, the seat-rail-locking device 17 is unlocked and the vehicle seat 1 can be displaced forward. This makes it possible to provide the largest possible entry or exit region for a seat which is arranged behind the vehicle seat 1, is not illustrated in the Figures and belongs to a rear, in particular third, row of seats.

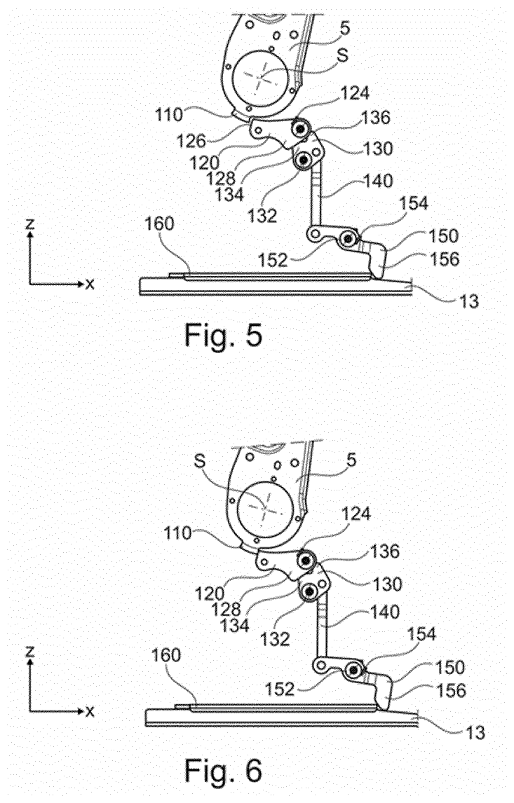

In the case of the seat-rail-locking device 17 being unlocked, the first rail 11 can be displaced relative to the second rail 13 within a comfort-setting region and, in addition, into an easy-entry region. The seat-rail-locking device 17 is provided in order to lock the first rail 11 to the second rail 13 in a position within the comfort-setting region. The seat-rail-locking device 17 does not function, that is to say the first rail 11 cannot be locked to the second rail 13, in an easy-entry region, which is illustrated in FIGS. 5 and 6.

Longitudinal adjustment of the vehicle seat 1 in the longitudinal direction x within the comfort-setting region, which comprises a plurality of lockable longitudinal-adjustment positions, takes place by virtue of the seat-rail-locking devices 17 being unlocked by means of a pivotable bracket 15, which is arranged in the front region of the vehicle seat 1, beneath the seat part 3, and of which the ends are operatively connected to the seat-rail-locking devices 17 in a manner known per se. The bracket 15 makes it possible for the pairs of rails 11, 13 to be unlocked manually by virtue of the bracket 15 being pulled upward. Displacement of the vehicle seat 1 within the comfort-setting region can take place as long as the bracket 15 is pulled upward and the seat-rail-locking devices 17 are therefore kept in a disengaged state. The bracket 15 here can be fitted on a reinforcing transfer bar, which is rotated when the bracket 15 is pulled upward. This transfer bar can be mounted on the respectively first rail 11, on either side of the seat, and provides coupling for the locking states of the two seat-rail-locking devices 17 of the two pairs of rails 11, 13.

A shiftable end stop, which is not illustrated in the Figures, but is known per se, delimits the comfort-setting region. In order to transfer from the comfort-setting region into the easy-entry region, the shiftable end stop can be shifted into an inactive position, and the vehicle seat 1 can be displaced into the easy-entry region, which is arranged in front of the comfort-setting region. The end stop can be shifted into the inactive position by means of a cable pull, which couples the end stop to the backrest 5, by virtue of the backrest 5 being pivoted into the entry position.

In the entry position, which is not suitable for transporting passengers and in which the backrest 5 has been pivoted forward about the pivot axis S and the vehicle seat 1 has been displaced forward into the easy-entry region, the backrest 5 can be locked by means of an additional backrest-locking mechanism 100, which will be described in more detail hereinbelow. It is possible to lock the longitudinal-adjustment position in the easy-entry region by means of an additional rail-locking mechanism 50, as is known, for example, from DE 10 2016 204 645 A1. However, the invention can also be used to full advantage without an additional rail-locking mechanism 50. To this extent, the additional rail-locking mechanism 50 can be regarded as being purely optional.

FIG. 2 shows the additional backrest-locking mechanism 100 in detail. The additional backrest-locking mechanism 100 has a stop part 110, which is fastened on a structure of the backrest 5, and also has an arresting catch 120, a control catch 130, a coupling element 140, a control lever 150 and a control contour 160.

The control contour 160 is fixed to the second rail 13, which is mounted on the vehicle structure, or it is formed in one piece therewith. The stop part 110 is fixed to the backrest 5, in particular to the first part of the fitting 7, said first fitting part being fixed to the structure of the backrest 5. The arresting catch 120 is connected to a structural part of the seat part 3 such that it can be pivoted by means of a rotary bearing 122. The control catch 130 is connected to a structural part of the seat part 3 such that it can be pivoted by means of a rotary bearing 132. The control lever 150 is connected to a structural part of the seat part 3 such that it can be pivoted by means of a rotary bearing 152. The coupling element 140 connects the control lever 150 to the control catch 130 such that a pivoting movement of the control lever 150 causes the control catch 130 to pivot.

The rotary bearing 122 of the arresting catch 120 is arranged above the rotary bearing 132 of the control catch 130. The rotary bearing 132 of the control catch 130 is arranged above the rotary bearing 152 of the control lever 150. The rotary bearing 122 of the arresting catch 120 is arranged slightly behind the rotary bearing 132 of the control catch 130, as seen in the longitudinal direction x. The rotary bearing 132 of the control catch 130 is arranged behind the rotary bearing 152 of the control lever 150, as seen in the longitudinal direction x. The rotary bearings 122, 132, 152 are each configured in the form of threaded bolts, in the present case hexagon-socket-head cap screws, which are each screwed into a structural part of the seat part 3.

The arresting catch 120 has an elongate extent. In a first end region, the arresting catch 120 has an opening for accommodating the rotary bearing 122. A second end region has a stop surface 126 for interacting with the stop part 110. The stop surface 126 is oriented more or less in the circumferential direction of the rotary bearing 122 and in the transverse direction. A cam 128 of the arresting catch 120 projects in the direction of the control catch 130. A spring 124, in the present case a leg spring, prestresses the arresting catch 120 such that the stop surface 126 is prestressed away from the pivot axis S. If the arresting catch 120 is not, as described hereinbelow, kept closed by the control catch 130, the stop surface 126 leaves a curved path of the stop part 110, this curved path being created by virtue of the backrest 5 pivoting about the pivot axis S.

The control catch 130 is of more or less rectangular basic shape. In one corner region, the control catch 130 has an opening for accommodating the rotary bearing 132. In a corner region adjacent to the opening, the control catch 130 has a point of articulation for articulating the coupling element 140 in a pivotable manner. In a further corner region adjacent to the opening, the control catch 130 has a control cam 134 for controlling pivoting movement of the arresting catch 120. The control cam 134 butts against the cam 128 of the arresting catch 120 such that pivoting of the control catch 130 causes the arresting catch 120 to pivot. In a corner region located opposite the opening for the rotary bearing 132, the control catch 130 has a stop cam 136. The stop cam 136 delimits a pivoting-angle range of the control catch 130. In a locked state of the arresting catch 120, the stop cam 136 butts against the arresting catch 120.

The control lever 150 is more or less L-shaped. More or less in the center of the control lever 150, the control lever 150 has an opening for accommodating the rotary bearing 152. In a first end region, the control lever 150 has a point of articulation for articulating the coupling element 140 in a pivotable manner. In an end region located opposite the point of articulation, the control lever 150 has a finger 156. The finger 156 projects perpendicularly from an imaginary straight line which runs respectively through the center of the opening and the center of the point of articulation. A spring 154 which acts on the control lever 150 prestresses the finger 156 in the direction of the control contour 160.

The coupling element 140 has an elongate extent. A first end region of the coupling element 140 is connected in a pivotable manner to the point of articulation of the control catch 130. A second end region of the coupling element is connected in a pivotable manner to the point of articulation of the control lever 150.

A pivoting movement of the control lever 150 causes, via the coupling element 140, the control catch 130 to pivot. The control catch 130 causes the arresting catch 120 to pivot in the manner described above, and therefore a pivoting movement of the control lever 150, at least after a possible inoperative angle has been negotiated, causes the arresting catch 120 to pivot.

If the longitudinal-adjustment position of the vehicle seat 1 is within the comfort-setting region, the finger 156 rests on the control contour 160. The control catch 130 is thus kept in an angular position in which the control catch 130 does not keep the arresting catch 120 in a closed angular position, and therefore the spring 124 pivots the arresting catch 120 into an open position and the stop part 110 can pivot past the stop surface 126 of the arresting catch 120. If the longitudinal-adjustment position of the vehicle seat 1 is outside the comfort-setting region, in particular in the easy-entry region, the finger 156 no longer rests on the control contour 160. On account of the prestressing by the spring 154, the control lever 150 has been pivoted to the extent where the finger 156 rests on the second rail 13. Via the coupling element 140, the control lever 150 pushes the control catch 130 into an angular position in which the control catch 130 pivots the arresting catch 120 such that the stop surface 126 projects into the curved path of the stop part 110, and therefore the backrest 5 cannot be pivoted back into the use position from the entry position.

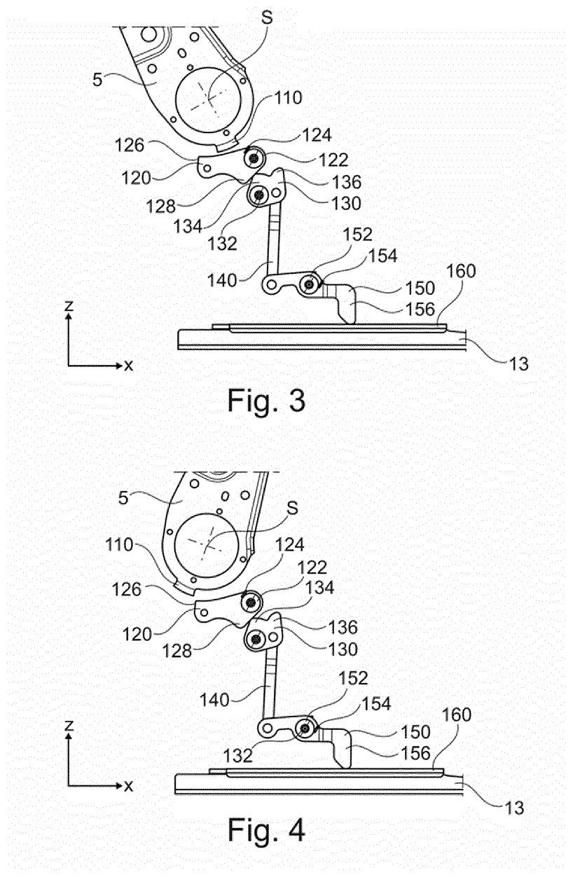

FIG. 3 illustrates the vehicle seat 1 in a locked, use position. The use position of the backrest 5 is locked by means of the fittings 7, which are not illustrated in FIG. 3. In the use position, the pairs of rails 11, 13 are locked by means of the seat-rail-locking devices 17. The finger 156 of the control lever 150 rests on the control contour 160, and therefore, in the manner described above, the stop surface 126 does not project into the curved path of the stop part 110.

In FIG. 4, the backrest 5 has been pivoted forward into the entry position. The fittings 7 here are unlocked, for example via a free-pivoting control element in the fittings 7, said element being known per se, for example from WO 2007/115601 A1, of which the relevant disclosure content is expressly included. When the backrest 5 is pivoted forward, the seat-rail-locking devices 17 are inevitably opened via a mechanism which is known per se. The seat-rail-locking devices 17 remain open as long as the backrest 5 is located in the entry position. A mechanism which opens the seat-rail-locking devices 17 when the backrest 5 is pivoted forward is known, for example, from WO 2015/117889 A1, of which the relevant disclosure content is expressly included. The finger 156 of the control lever 150 rests on the control contour 160, and therefore the stop surface 126 does not project into the curved path of the stop part 110.

In the illustration of FIG. 5, the vehicle seat 1 is located fully in the entry position. The finger 156 of the control lever 150 rests on the second rail 13, in front of the control contour 160, and therefore, in the manner described above, the stop surface 126 projects into the curved path of the stop part 110. The additional backrest-locking mechanism 100 is thus locked. The situation where the backrest 5 pivots back is avoided as a result. In the illustration of FIG. 5, the backrest has been pivoted forward slightly beyond the entry position, and therefore there is a small spacing between the stop surface 126 and the stop part 110. This spacing is eliminated as soon as the backrest 5 is moved slightly in the direction of the use position, for example on account of pressure between a cushion of the seat part 3 and a cushion of the backrest 5. This state is illustrated in FIG. 6. The fittings 7 remain unlocked. The seat-rail-locking devices 17 likewise remain unlocked. Since the additional backrest-locking mechanism 100 and, if present, the additional rail-locking mechanism 50 are locked, an occupant of a row of seats arranged behind the vehicle seat 1 can hold onto the backrest 5 and/or pull himself forward as he is exiting the vehicle.

In order to transfer the vehicle seat 1 from the entry position back into the use position, the vehicle seat 1 is pushed rearward. The additional backrest-locking mechanism 100 unlocks as soon as the control lever 150 runs onto the first control contour 160 again.

The features disclosed in the above description, the claims and the drawings may be important both individually and in combination for the purpose of realizing the various configurations of the invention.

Although the invention has been described in detail in the drawings and the description above, what has been said and illustrated should be understood as being illustrative and exemplary and not restrictive. In particular, the choice of the proportions of the individual elements illustrated in the drawings should not be interpreted as necessary or limiting. Furthermore, the invention is in particular not limited to the exemplary embodiments explained. Further variants of the invention and the implementation thereof are apparent to a person skilled in the art from the above disclosure, the Figures and the claims.

Terms such as “comprise”, “have”, “include”, “contain” and the like used in the claims do not rule out other elements or steps. The use of the indefinite article does not rule out a plurality. An individual device can perform the functions of a plurality of devices or units mentioned in the claims.

While specific embodiments of the invention have been shown and described in detail to illustrate the application of the principles of the invention, it will be understood that the invention may be embodied otherwise without departing from such principles.

1. A vehicle seat comprising:
a seat part
a backrest;
at least one lockable fitting pivotably attaching the backrest to the seat part for pivoting the backrest about a pivot axis;
at least one pair of rails for adjusting the vehicle seat longitudinally;
a seat-rail-locking device for locking the at least one pair of rails in at least one use position of the vehicle seat, said at least one use position being suitable for transporting passengers, wherein the vehicle seat can be transferred into an entry position, in which the vehicle seat has been displaced, in relation to the at least one use position, into an easy-entry region by means of the at least one pair of rails, the backrest has been pivoted forward about the pivot axis and the backrest can be locked in the forwardly pivoted position;
an additional backrest-locking mechanism for locking the backrest in the forwardly pivoted position, the additional backrest-locking mechanism being formed separately from the at least one fitting, the additional backrest-locking mechanism comprising: a stop part, which is rotationally fixedly connected to the backrest; an arresting catch a control lever; a control catch; and a control contour, which is fixed to a vehicle-mounted rail of the at least one pair of rails, wherein the control contour acts on the control lever such that, in the entry position, the control lever assumes a different angular position than in the at least one use position, and the control lever is operatively connected to the arresting catch such that, in the entry position, the arresting catch assumes a different angular position than in the at least one use position, and therefore, in the at least one use position, the stop part can be pivoted past the arresting catch, and, in the entry position, the arresting catch prevents the stop part from pivoting past, wherein, in the entry position, the arresting catch is pivoted directly by the control catch such that the arresting catch prevents the stop part from pivoting past the arresting catch.

2. The vehicle seat as claimed in claim 1, wherein the arresting catch is prestressed by means of a spring in a direction of an angular position of the arresting catch, in which the arresting catch allows the stop part to pivot past the arresting catch.

3. The vehicle seat as claimed in claim 1, wherein the control lever has a finger, wherein, within the comfort-setting region, the finger rests on the control contour.

4. The vehicle seat as claimed in claim 3, wherein the additional backrest-locking mechanism further comprises a spring acting on the control lever to prestress the finger in a direction of the control contour.

5. The vehicle seat as claimed in claim 1, wherein the additional backrest-locking mechanism further comprises a coupling element and the control catch is connected to the control lever via the coupling element.

6. The vehicle seat as claimed in claim 5, wherein the coupling element has an elongate extent.

7. The vehicle seat as claimed in claim 5, wherein a first end region of the coupling element is pivotably connected to a point of articulation of the control catch, and a second end region of the coupling element is pivotably connected to a point of articulation of the control lever.

8. The vehicle seat as claimed in claim 1, wherein the arresting catch has a stop surface for interacting with the stop part.

9. The vehicle seat as claimed in claim 1, wherein the control catch has a control cam for controlling a pivoting movement of the arresting catch.

10. The vehicle seat as claimed in claim 1, wherein the arresting catch has a cam, which projects in the direction of the control catch.

11. The vehicle seat as claimed in claim 10, wherein:
the control catch has a control cam for controlling a pivoting movement of the arresting catch; and
the control cam butts against the cam of the arresting catch such that pivoting of the control catch causes the arresting catch to pivot.

12. The vehicle seat as claimed in claim 1, wherein the control catch has a stop cam which delimits a pivoting-angle range of the control catch.

13. The vehicle seat as claimed in claim 12, wherein, in a locked state of the arresting catch, the stop cam butts against the arresting catch.

14. The vehicle seat as claimed in claim 1, further comprising an additional rail-locking mechanism configured to lock a longitudinal-adjustment position in the easy-entry region.

15. The vehicle seat as claimed in claim 14, wherein, in the use position, the additional rail-locking mechanism is open irrespective of a locking state of the seat-rail-locking device.
